(19) United States
(12) Patent Application Publication
(10) Pub. No.: US 2019/0306679 A1
(43) Pub. Date: Oct. 3, 2019

(54) SYSTEMS AND METHODS FOR MONITORING A VEHICLE

(71) Applicant: JIANGSU HONGBAO HARDWARE CO., LTD., Suzhou (CN)

(72) Inventors: Wei DUAN, Beijing (CN); Tao FANG, Beijing (CN); Zhifeng HU, Beijing (CN); Chunxu YANG, Beijing (CN)

(73) Assignee: JIANGSU HONGBAO HARDWARE CO., LTD., Suzhou (CN)

(21) Appl. No.: 16/443,851

(22) Filed: Jun. 17, 2019

Related U.S. Application Data
(63) Continuation of application No. PCT/CN2017/117812, filed on Dec. 21, 2017.

(30) Foreign Application Priority Data
Dec. 22, 2016 (CN) 201621423996.8
Dec. 28, 2016 (CN) 201611231465.3
Dec. 28, 2016 (CN) 201611237000.9
Dec. 28, 2016 (CN) 201621455153.6
Feb. 10, 2017 (CN) 201710074391.5
May 10, 2017 (CN) 201710324134.2

(51) Int. Cl. H04W 4/40; H04W 4/23; B60Q 9/00; B60R 25/102; B60R 25/10; B60R 25/20

(52) U.S. Cl. CPC H04W 4/40; H04W 4/23; B60Q 9/00; B60R 2325/101; B60R 25/1001; B60R 25/20; B60R 25/102

(57) ABSTRACT

A system includes a storage device storing a set of instructions and one or more processors in communication with the storage device. When executing the set of instructions, the processors are configured to cause the system to obtain information associated with a vehicle and a user that uses the vehicle via a network. The processors also cause the system to determine at least one behavior of the user based on the multimedia information. The processors also cause the system to generate at least one message in response to the behavior of the user, and transmit the message to the vehicle or a terminal device of the user via the network. The processors also cause the system to determine broadcast data based on the information. The processors also cause the system to transmit the broadcast data to the vehicle or the terminal device of the user via the network.

### CROSS-REFERENCE TO RELATED APPLICATION

This application is a Continuation of International Application No. PCT/CN2017/117812, filed on Dec. 21, 2017, which claims priority to Chinese Patent Application No. 201710324134.2, filed on May 10, 2017, Chinese Patent Application No. 201621423996.8, filed on Dec. 22, 2016, Chinese Patent Application No. 201611237000.9, filed on Dec. 28, 2016, Chinese Patent Application No. 201710074391.5, filed on Feb. 10, 2017, Chinese Patent Application No. 201611231465.3, filed on Dec. 28, 2016, and Chinese Patent Application No. 201621455153.6, filed on Dec. 28, 2016, the contents of each of which are hereby incorporated by reference.

### TECHNICAL FIELD

The present disclosure generally relates to monitoring systems, and more particularly, to systems and methods for monitoring information associated with a vehicle and/or a user.

### BACKGROUND

The functionality of sharing vehicles seems simple at the moment; however, it is important to provide the sharing vehicles various functionalities (e.g., monitoring information associated with the vehicles, monitoring information associated with users that use the vehicle), which may improve the user experience. Thus, it may be desirable to develop systems and methods to monitor the information associated with the users and/or the vehicles.

### SUMMARY

According to an aspect of the present disclosure, a system may include a storage device storing a set of instructions and one or more processors in communication with the storage device. When executing the instructions, one or more processors may be configured to cause the system to obtain, via a network, multimedia information associated with a user, the multimedia information being detected by at least one detector installed on a vehicle. The one or more processors may also cause the system to determine, based on the multimedia information associated with the user, at least one behavior of the user and generate at least one message in response to the at least one behavior of the user. The one or more processors may further cause the system to transmit, via the network, the at least one message to the vehicle or a terminal device of the user.

In some embodiments, the multimedia information associated with the user may include at least one of: image information, sound information, or video information.

In some embodiments, the at least one behavior of the user may include at least one of: wearing earphones while driving or riding the vehicle, making a phone call while driving or riding the vehicle, running a red light, damaging the vehicle, tampering with a lock of the vehicle, and/or using a manual communication.

In some embodiments, the one or more processors may also cause the system to determine whether the at least one behavior of the user includes at least one of: wearing earphones while driving or riding the vehicle, making a phone call while driving or riding the vehicle, or running a red light and in response to a result of the determination that the at least one behavior of the user includes at least one of: wearing earphones while driving or riding the vehicle, making a phone call while driving or riding the vehicle, or running a red light, transmit, via the network, a message of reminding the user to travel safely to the vehicle or the terminal device.

In some embodiments, the one or more processors may also cause the system to determine whether the at least one behavior of the user includes damaging the vehicle and in response to a result of the determination that the at least one behavior of the user includes damaging the vehicle, transmit, via the network, a warning to the vehicle or the terminal device.

In some embodiments, the one or more processors may also cause the system to determine whether the at least one behavior of the user includes tampering with a lock of the vehicle. In response to a result of the determination that the at least one behavior of the user includes tampering with the lock of the vehicle, the one or more processors may further cause the system to transmit, via the network, a warning to the vehicle or the terminal device and transmit, via the network, the multimedia information associated with the user and an identifier of the vehicle to a server.

In some embodiments, the one or more processors may also cause the system to determine whether the at least one behavior of the user includes using a manual communication and in response to a result of the determination that the at least one behavior of the user includes using a manual communication, transmit, via the network, a message through sign languages to the vehicle or the terminal device of the user.

According to another aspect of the present disclosure, a system may include a storage device storing a set of instructions and one or more processors in communication with the storage device. When executing the instructions, one or more processors may be configured to cause the system to obtain, via a network, information associated with a vehicle. The one or more processors may also cause the system to determine, based on the information associated with the vehicle, broadcast data and transmit, via the network, the broadcast data to the vehicle or a terminal device of a user that uses the vehicle.

In some embodiments, the information associated with the vehicle may include at least one of multimedia information, speed information, environment information, location information, lock information, noise information, advertisement information, or battery information.

In some embodiments, the lock information may include a status change of a lock of the vehicle from being locked to unlocked or from being unlocked to locked and the broadcast data may include broadcast data relating to the status change of the lock of the vehicle.

In some embodiments, the environment information may be associated with an area where the vehicle is located. In some embodiments, the environment information may include at least one environmental parameter of the vehicle and the at least one environmental parameter may include at least one of temperature, humidity, wind, or dust. The one or more processors may also cause the system to determine whether a value of the at least one environmental parameter exceeds a threshold and in response to a result of the determination that the at least one environmental parameter exceeds the threshold, transmit, via the network, broadcast data relating to the at least one environmental parameter to the vehicle or the terminal device of the user.

In some embodiments, the speed information may include an acceleration of X-axis, an acceleration of Y-axis, and an acceleration of Z-axis. The one or more processors may also cause the system to determine whether the acceleration of X-axis and the acceleration of Z-axis are abnormal when a lock of the vehicle is unlocked or the acceleration of Y-axis and the acceleration of Z-axis are abnormal when the lock is unlocked. In response to a result of the determination that the acceleration of X-axis and the acceleration of Z-axis are abnormal when the lock is unlocked or the acceleration of Y-axis and the acceleration of Z-axis are abnormal when the lock is unlocked, the one or more processors may further cause the system to transmit, via the network, a request for calling for help and a location of the vehicle to a server.

In some embodiments, the one or more processors may also cause the system to determine whether the acceleration of X-axis or the acceleration of Y-axis is abnormal when the lock is locked and in response to a result of the determination that the acceleration of X-axis or the acceleration of Y-axis is abnormal when the lock is locked, transmit, via the network, a request for tracking the vehicle and the location of the vehicle to a server.

In some embodiments, the one or more processors may also cause the system to determine, based on the noise information, whether at least one part of the vehicle is malfunctional. In response to a result of the determination that the at least one part of the vehicle is malfunctional, the one or more processors may further cause the system to transmit, via the network, broadcast data for reminding the user to drive carefully to the vehicle or the terminal device of the user and transmit, via the network, a request for repairing the at least one part of vehicle that is malfunctional to a server.

In some embodiments, the one or more processors may also cause the system to filter out environmental noise information from the noise information and determine a frequency value of the filtered noise information based on an analog-to-digital converter.

In some embodiments, the location information may include the location of the vehicle and the advertisement information may include a location of a shop. The one or more processors may also cause the system to determine whether a distance between the location of the vehicle and the location of the shop is less than a distance threshold and in response to a result of the determination that the distance between the location of the vehicle and the location of the shop is less than a distance threshold, transmit, via the network, broadcast data of the advertisement information to the vehicle or the terminal device of the user.

In some embodiments, the one or more processors may also cause the system to obtain, via a Bluetooth signal, the location information associated with the vehicle, the Bluetooth signal including an identifier of the vehicle and determine, based on the identifier of the vehicle, the location of the vehicle.

In some embodiments, the battery information may include remaining capacity of a battery of the vehicle. The one or more processors may also cause the system to transmit, via the network, broadcast data of the remaining capacity of the battery to a server.

According to yet another aspect of the present disclosure, a computer-implemented method may include one or more of the following operations performed by one or more processors. The method may include obtaining, via a network, multimedia information associated with a user, the multimedia information being detected by at least one detector installed on a vehicle and determining, based on the multimedia information associated with the user, at least one behavior of the user. The method may also include generating at least one message in response to the at least one behavior of the user and transmitting, via the network, the at least one message to the vehicle or a terminal device of the user.

According to yet another aspect of the present disclosure, a computer-implemented method may include one or more of the following operations performed by one or more processors. The method may include obtaining, via a network, information associated with a vehicle and determining, based on the information associated with the vehicle, broadcast data. The method may also include transmitting, via the network, the broadcast data to the vehicle or a terminal device of a user that uses the vehicle.

According to yet another aspect of the present disclosure, a vehicle may include a storage device and a processor in communication with the storage device. The storage may include a set of instructions. When executing the set of instructions, the processor is configured to cause the vehicle to obtain multimedia information associated with a user, the multimedia information being detected by at least one detector installed on the vehicle and transmit, via a network, the multimedia information associated with the user to a server. The processor may also cause the vehicle to obtain, via the network, from the server, at least one message indicating that a behavior of the user determined based on the multimedia information and broadcast the at least one message to the user or a server.

According to yet another aspect of the present disclosure, a vehicle may include a storage device and a processor in communication with the storage device. The storage may include a set of instructions. When executing the set of instructions, the processor is configured to cause the vehicle to obtain information associated with a vehicle, the information being detected by at least one detector installed on the vehicle and transmit, via a network, the information associated with the vehicle to a server. The processor may also cause the vehicle to obtain, via the network, broadcast data determined by a server based on the information associated with the vehicle and broadcast the broadcast data to a user or a server.

According to yet another aspect of the present disclosure, a non-transitory computer-readable medium may store instructions. When executed by one or more processors of a system, the instructions may cause the system to obtain, via a network, multimedia information associated with a user, the multimedia information being detected by at least one detector installed on a vehicle and determine, based on the multimedia information associated with the user, at least one behavior of the user. The instructions may also cause the system to generate at least one message in response to the at least one behavior of the user and transmit, via the network, the at least one message to the vehicle or a terminal device of the user.

According to yet another aspect of the present disclosure, a non-transitory computer-readable medium may store instructions. When executed by one or more processors of a system, the instructions may cause the system to obtain, via a network, information associated with a vehicle and determine, based on the information associated with the vehicle, broadcast data. The instructions may also cause the system to transmit, via the network, the broadcast data to the vehicle or a terminal device of a user that uses the vehicle.

According to yet another aspect of the present disclosure, a system may include an obtainment module, a determination module, a generation module, and a generation module. The obtainment module may be configured to obtain, via a network, multimedia information associated with a user and the determination module may be configured to determine, based on the multimedia information associated with the user, at least one behavior of the user. The generation module may be configured to generate at least one message in response to the at least one behavior of the user, and the transmission module may be configured to transmit, via the network, the at least one message to the vehicle or a terminal device of the user.

According to yet another aspect of the present disclosure, a system may include an obtainment module, a determination module, and a generation module. The obtainment module may be configured to obtain, via a network, information associated with a vehicle and the determination module may be configured to determine, based on the information associated with the vehicle, broadcast data. The transmission module may be configured to transmit, via the network, the broadcast data to the vehicle or a terminal device of a user that uses the vehicle.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary vehicle sharing system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a schematic diagram illustrating an exemplary vehicle according to some embodiments of the present disclosure;

FIG. 5 is a block diagram illustrating hardware and/or software components of an exemplary vehicle according to some embodiments of the present disclosure;

FIG. 6 is a block diagram illustrating an exemplary processing device according to some embodiments of the present disclosure;

FIG. 7 is a flowchart illustrating an exemplary process for transmitting a message according to some embodiments of the present disclosure;

FIG. 8 is a flowchart illustrating an exemplary process for transmitting broadcast data according to some embodiments of the present disclosure;

FIG. 9 is a flowchart illustrating an exemplary process for determining a frequency value of filtered noise information based on an analog-to-digital converter according to some embodiments of the present disclosure;

FIG. 10 is a flowchart illustrating an exemplary process for determining a location of a vehicle according to some embodiments of the present disclosure;

FIG. 11 is a schematic diagram illustrating an exemplary lock according to some embodiments of the present disclosure; and

FIG. 12 is a schematic diagram illustrating an exemplary power supply according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is to describe particular exemplary embodiments only and is not intended to be limiting. As used herein, the singular forms “a,” “an,” and “the” may be intended to include the plural forms as well, unless the context expressly indicates otherwise. It will be further understood that the terms “comprise,” “comprises,” and/or “comprising,” “include,” “includes,” and/or “including,” when used in the present disclosure, specify the presence of stated features, integers, steps, operation, elements, and/or components, but do not preclude the presence or addition of one or more other features, integers, steps, operation, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of the present disclosure. It is to be expressly understood, however, that the drawings are for illustration and description only, and are not intended to limit the scope of the present disclosure. It is understood that the drawings are not to scale.

It will be understood that the term “system,” “engine,” “unit,” and/or “module” used herein are one method to distinguish different components, elements, parts, sections, or assemblies of different levels in ascending order. However, the terms may be displaced by other expressions if they achieve the same purpose.

It will be understood that when a unit, engine, or module is referred to as being “on,” “connected to,” or “coupled to,” another unit, engine, or module, it may be directly on, connected or coupled to, or communicate with the other unit, engine, or module, or an intervening unit, engine, or module may be present, unless the context clearly indicates otherwise. As used herein, the term “and/or” includes any and all combinations of one or more of the associated listed items.

The flowcharts used in the present disclosure illustrate operation that systems implement according to some embodiments of the present disclosure. It is to be expressly understood, the operation of the flowcharts may be implemented not in order. Conversely, the operation may be implemented in inverted order, or simultaneously. Moreover, one or more other operation may be added to the flowcharts. One or more operations may be omitted from the flowcharts.

Moreover, while the systems and methods described in the present disclosure are described primarily regarding a vehicle security/sharing service, it should also be understood that they are merely exemplary embodiments. The systems or methods described in the present disclosure may apply to any other kind of economic sharing service that transfers a usufruct from one to another in an online rental transaction. For example, the systems or methods of the present disclosure may apply to physical asset renting and/or a labor service. The physical asset may include real estate (e.g., a hotel, a room, or an apartment), vehicles (e.g., a car, a bicycle, an electric bicycle, a bus, a hot-air balloon, or an airplane), goods (e.g., clothes, an umbrella, a charger, or a microphone), etc. The labor service may include pet adoption, housekeeping, designated driving, etc. The application of the systems or methods of the present disclosure may include a web page, a plug-in for a browser, a client terminal, a custom system, an internal analysis system, an artificial intelligence robot, or the like, or any combination thereof.

The terms “cyclist,” “requestor,” “service requestor,” “cyclist terminal,” “requestor terminal,” and “user” in the present disclosure are used interchangeably to refer to an individual, an entity, or a tool that may request or order a vehicle sharing service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

It should be noted that the vehicle security/sharing service is a new form of service rooted only in the post-Internet era. It provides technical solutions to users and service providers that could raise only in the post-Internet era. In the pre-Internet era, when a user needs to rent a vehicle in a vehicle rental shop, the vehicle request and acceptance occur only between the user and a shopkeeper of the vehicle rental shop who meet each other at a physical place. Through the Internet (and/or other types of network technology like Bluetooth), the vehicle sharing service, however, allows a user of the service to acquire a location of a vehicle accurately and rent a vehicle anywhere and anytime. It also allows the user to park the vehicle in any area where the parking of the vehicle is allowed. Therefore, through the Internet, a vehicle security/sharing system may provide a more convenient transaction platform for users and service providers that may never meet in the settings of the traditional, pre-Internet vehicle service.

An aspect of the present disclosure relates to a method for monitoring a vehicle. According to the aspect of the present disclosure, the method may include obtaining multimedia information associated with a user. At least one behavior of the user may be determined based on the multimedia information. A message may be determined based on the user behavior. The message may be transmitted to a terminal device of the user. In some embodiments, information associated with the vehicle may be determined. Broadcast data may be determined based on the information. The broadcast data may be transmitted to the vehicle or a terminal device of the user.

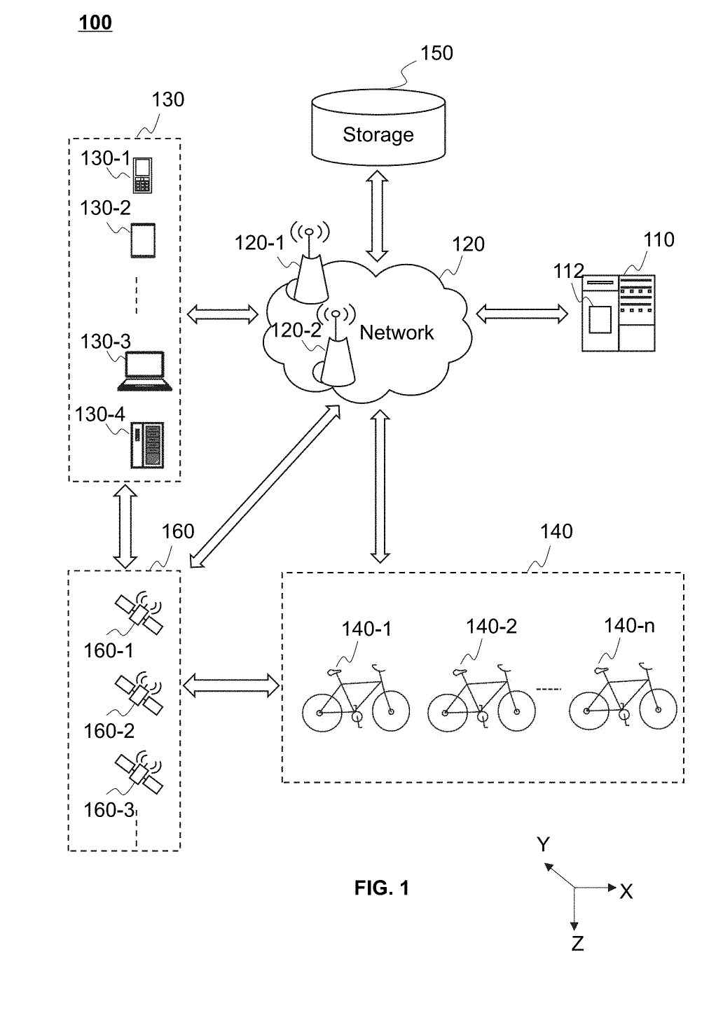

FIG. 1 is a schematic diagram illustrating an exemplary vehicle sharing system 100 according to some embodiments of the present disclosure. The vehicle sharing system 100 may include a server 110, a network 120, one or more terminal devices 130, one or more vehicles 140, a storage 150, and a positioning device 160. The vehicle sharing system 100 may provide a vehicle sharing service allowing a user to use a vehicle (e.g., the vehicle 140) for a ride or drive. When the user finishes the ride or drive and wants to return the vehicle, the user may leave the vehicle in any area where the parking of the vehicle is permitted and lock the vehicle. The vehicle may then be ready for a next user.

The server 110 may communicate with the terminal device 130 and/or the vehicle 140 to provide various functionalities of the vehicle sharing service. For example, the server 110 may receive a service request from the terminal device 130 via, for example, the network 120. The service request may include order information relating to the ride or drive and/or the vehicle 140, including, for example, a vehicle type, a departing place, a destination, mileage, a route, or the like, or any combination thereof. The service request may also include the information relating the user (e.g., the user account information) and/or the terminal device 130 (e.g., the location of the terminal device 130).

The server 110 may also transmit information to the terminal device 130 and/or the vehicle 140. For instance, the server 110 may determine one or more vehicles 140 in response to the service order received from the terminal device 130 and transmit the information relating to the one or more vehicles 140 to the terminal device 130, including, for example, the locations of the one or more vehicles 140, the fees for the ride or the drive (e.g., the total fees for the ride or drive, the hourly rate for the ride or drive), or the like, or a combination thereof. The server 110 may also transmit to a vehicle 140 an instruction to lock the vehicle 140, an instruction to unlock the vehicle 140, and/or the information related to the vehicle 140 (e.g., the information indicating that the vehicle is out of range, navigation information).

The server 110 may determine a hotspot area based on historical data obtained from the terminal device 130, the vehicle 140, and/or the storage 150. The hotspot area may be an area where vehicles are in high demand. The historical data may include the number of searches for a vehicle in an area. The historical data may also include data relating to historical service orders (e.g., the number of times that the vehicles 140 have been used in an area). The historical data may further include information provided by users via the terminal devices 130 (e.g., advice to place more vehicles in some area submitted by users). The server 110 may also provide a service fee management. The server 110 may determine the cost of a ride or drive based on a monthly membership, a quarterly membership, a season (e.g., spring, summer) membership, an annual membership, or fees per ride or drive.

In some embodiments, the server 110 may be a single server or a server group. The server group may be a centralized server group connected to the network 120 via an access point or a distributed server group connected to the network 120 via one or more access points, respectively. In some embodiments, the server 110 may be locally connected to the network 120 or in remote connection with the network 120. For example, the server 110 may access information and/or data stored in the terminal device 130, the vehicle 140, and/or the storage 150 via the network 120. As another example, the storage 150 may serve as backend data storage of the server 110. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the server 110 may include a processing engine 112. The processing engine 112 may process information and/or data related to performing one or more functions in the present disclosure. For example, the processing engine 112 may process operation information of a lock to determine the status of the lock. In some embodiments, the processing engine 112 may include one or more processing units (e.g., single-core processing engine(s) or multi-core processing engine(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the vehicle sharing system 100 (e.g., the server 110, the terminal device 130, the vehicle 140, or the storage 150) may transmit information and/or data to another component(s) in the vehicle sharing system 100 via the network 120. For example, the server 110 may access and/or obtain data of a plurality of vehicles 140 from the storage 150 via the network 120. For example, the server 110 may transmit the distribution of vehicles 140 near the location of the terminal device 130 to the terminal device 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the vehicle sharing system 100 may be connected to the network 120 to exchange data and/or information.

In some embodiments, a user may be an owner of the terminal device 130. The terminal device 130 may receive input from the user and transmit the information relating to the input to the server 110 via the network 120. The terminal device 130 may also receive information from the server 110 via the network 120. For example, the terminal device 130 may receive input from the user relating to a service request for a vehicle to the server 110, receive a service confirmation, and/or information or instructions from the server 110. Merely by way of example, the terminal device 130 may be configured to transmit a service request to the server 110 for searching for vehicles 140 near the location of the terminal device 130. The server 110 may determine one or more vehicles 140 (e.g., the locations of the vehicles 140, number of the vehicles 140) near the location of the terminal device 130 according to and in response to the service request. The server 110 may also transmit information relating to the determined one or more vehicles 140 to the terminal device 130 via the network 120. The information of the determined one or more vehicles 140 may be displayed on the terminal device 130 associated with an electronic map. The terminal device 130 may receive input from the user indicating a selected vehicle 140 from the vehicles 140 displayed on the terminal device 130, which may be transmitted to the server 110. The terminal device 130 may also provide a walking navigation for guiding the user to the location of the selected vehicle 140. As another example, the terminal device 130 may receive input from the user for reserving a vehicle 140 and transmit the information to the server 110. As yet another example, the terminal device 130 may transmit feedback information provided by the user to the server 110. The feedback information may include the status of the vehicle 140 (e.g., whether any part of the vehicle 140 needs to be repaired), improvement suggestions, etc.

In some embodiments, the terminal device 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glass, a smart helmet, a smartwatch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include a built-in computer, a built-in onboard television, a built-in tablet, etc. In some embodiments, the terminal device 130 may include a signal transmitter and a signal receiver configured to communicate with the positioning device 160 for locating the position of the user and/or the terminal device 130.

The vehicle 140 may include a plurality of vehicles 140-1, 140-2, . . . , 140-n. The vehicle 140 may be any type of vehicle including, for example, a unicycle, a bicycle, a tricycle, a tandem, a motor vehicle, an electric vehicle, a moped, etc. In the present application, the vehicle 140 may be described in the form of bicycle as examples for illustration purposes, and it should not be interpreted to limit the vehicle 140 to the form of bicycle only. The color of a vehicle 140 is not limiting. Merely by way of example, the color of the body of the vehicle 140 may be yellow. In some embodiments, a vehicle 140 may be identified with a unique symbol. The unique symbol may include a barcode, a quick response (QR) code, a serial number including letters and/or digits, or the like, or any combination thereof. For example, the identification (ID) of the vehicle 140 may be obtained by scanning the QR code of the vehicle 140 through a mobile application of the terminal device 130.

The vehicle 140 may communicate with the server 110, the network 120, the terminal device 130, and/or the positioning device 160. For example, the vehicle 140 may transmit status information of the vehicle 140 to the server 110 via the network 120. The status information may include a location of the vehicle 140, a locked/unlocked status of the vehicle 140, a riding distance, a riding duration time, and/or a riding speed of the vehicle 140, battery power of the vehicle 140, or the like, or a combination thereof. The server 110 may monitor the vehicle 140 based on the status information. As another example, the vehicle 140 may receive an instruction (e.g., an instruction to lock/unlock the vehicle 140) from the terminal device 130 and/or the server 110. As yet another example, the vehicle 140 may include a signal transmitter and a signal receiver (e.g., a GPS component of the vehicle 140) configured to communicate with the positioning device 160 for locating a position of the vehicle 140.

The storage 150 may store data and/or instructions. The data may include data related to users, terminal devices 130, vehicles 140, etc. The data related to the users may include user profiles including for example, names of the users, mobile numbers of the users, ID numbers of the users, types of the users (e.g., annual card users, quarterly card users, or monthly card users), usage records of the users (e.g., riding time, cost), credit rating of the users, historical routes, account balance, etc. The data related to the vehicles 140 may include service conditions of the vehicles (an inactive state, a booking state, on a ride or drive, in a maintenance state, in a loss state), positions of the vehicles, types of the vehicles (e.g., a car, a unicycle, a bicycle, a tricycle, a tandem, a motor bicycle, an electric bicycle), etc. In some embodiments, the storage 150 may store data obtained from the terminal device 130 and/or the vehicle 140. For example, the storage 150 may store log information associated with the terminal device 130. In some embodiments, the storage 150 may store data and/or instructions that the server 110 may execute or use to perform exemplary methods described in the present disclosure.

In some embodiments, the storage 150 may include a mass storage, removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

The positioning device 160 may determine information associated with an object, for example, one or more of the terminal device 130, or the vehicle 140. For example, the positioning device 160 may determine a current time and a current location of the terminal device 130 and/or the vehicle 140. In some embodiments, the positioning device 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, and/or a current time. The location may be in the form of coordinates, such as a latitude coordinate and a longitude coordinate, etc. The positioning device 160 may include one or more satellites, for example, a satellite 160-1, a satellite 160-2, and a satellite 160-3. The satellite 160-1 through 160-3 may determine the information mentioned above independently or jointly. The positioning device 160 may transmit the information mentioned above to the terminal device 130, or the vehicle 140 via the network 120.

In some embodiments, one or more components of the vehicle sharing system 100 may access the data and/or instructions stored in the storage 150 via the network 120. In some embodiments, the storage 150 may be directly connected to the server 110 as a backend storage. In some embodiments, one or more components of the vehicle sharing system 100 (e.g., the server 110, the terminal device 130, or the vehicle 140) may have permissions to access the storage 150. In some embodiments, one or more components of the vehicle sharing system 100 may read and/or modify the information related to the user, and/or the vehicle 140 when one or more conditions are met. For example, the server 110 may read and/or modify one or more users' information after a ride or drive of the vehicle 140 is completed.

In some embodiments, the information exchange between one or more components of the vehicle sharing system 100 may be initiated by way of launching the mobile application of the vehicle sharing service on a terminal device 130, requesting a vehicle service, or inputting a query via the terminal device 130 (e.g., searching for a vehicle). The object of the service request may be any product. In some embodiments, the product may include food, medicine, commodity, chemical product, electrical appliance, clothing, car, housing, luxury, or the like, or any combination thereof. In some other embodiments, the product may include a service product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistant (PDA), a smartwatch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc.

One of ordinary skill in the art would understand that when an element of the vehicle sharing system 100 performs, the element may perform through electrical signals and/or electromagnetic signals. For example, when a terminal device 130 processes a task, such as making a determination, unlocking a vehicle 140, the terminal device 130 may operate logic circuits in its processor to process such task. When the terminal device 130 transmits out a query (e.g., information relating to a location of a vehicle 140) to the server 110, a processor of the terminal device 130 may generate electrical signals encoding the query. The processor of the terminal device 130 may then transmit the electrical signals to an output port. If the terminal device 130 communicates with the server 110 via a wired network, the output port may be physically connected to a cable, which further transmits the electrical signal to an input port of the server 110. If the terminal device 130 communicates with the server 110 via a wireless network, the output port of the terminal device 130 may be one or more antennas, which convert the electrical signals to electromagnetic signals. Similarly, a vehicle 140 may process a task through operation of logic circuits in its processor, and receive an instruction and/or service order from the server 110 via electrical signals or electromagnet signals. Within an electronic device, such as the terminal device 130, the vehicle 140, and/or the server 110, when a processor thereof processes an instruction, transmits out an instruction, and/or performs an action, the instruction and/or action is conducted via electrical signals. For example, when the processor retrieves data (e.g., a plurality of user profiles) from a storage medium (e.g., the storage 150), it may transmit out electrical signals to a reading device of the storage medium, which may read structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

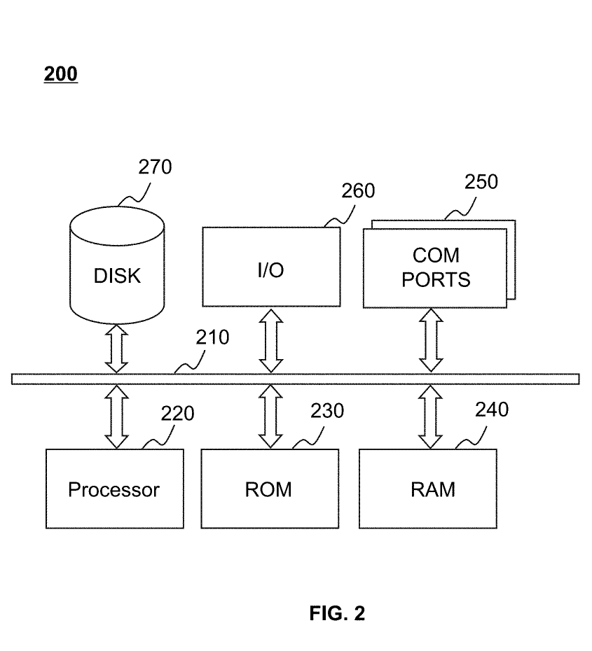

FIG. 2 a schematic diagram illustrating exemplary hardware and/or software components of a computing device 200 according to some embodiments of the present disclosure. The computing device 200 may be a general-purpose computer or a special purpose computer. The computing device 200 may be used to implement any component of the vehicle sharing system 100 as described herein. For example, the processing engine 112 of the server 110, and/or the terminal device 130 may be implemented on the computing device 200, via its hardware, software program, firmware, or a combination thereof. Although only one such computer is shown for convenience, the computer functions related to the vehicle sharing service as described herein may be implemented in a distributed manner on a number of similar platforms to distribute the processing load.

The computing device 200, for example, may include COM ports 250 connected to and from a network (e.g., the network 120) connected thereto to facilitate data communications. The computing device 200 may also include a processor 220 for executing program instructions to perform the functions of the server 110 described herein. The exemplary computer platform may include an internal communication bus 210, program storage and data storage of different forms, for example, a disk 270, and a read-only memory (ROM) 230, or a random access memory (RAM) 240, for various data files to be processed and/or transmitted by the computer. The exemplary computer platform may also include program instructions stored in the ROM 230, the RAM 240, and/or another type of non-transitory storage medium to be executed by the processor 220. The methods and/or processes of the present disclosure may be implemented as the program instructions. The computing device 200 also includes an I/O 260, supporting input/output between the computer, the user, and other components therein. The computing device 200 may also receive programming and data via network communications.

Merely for illustration, only one CPU and/or processor is described in the computing device 200. However, it should be noted that the computing device 200 in the present disclosure may also include multiple CPUs and/or processors, thus operation and/or method steps that are performed by one CPU and/or processor as described in the present disclosure may also be jointly or separately performed by the multiple CPUs and/or processors. For example, the CPU and/or processor of the computing device 200 may execute both step A and step B. As in another example, step A and step B may also be performed by two different CPUs and/or processors jointly or separately in the computing device 200 (e.g., the first processor executes step A and the second processor executes step B, or the first and second processors jointly execute steps A and B).

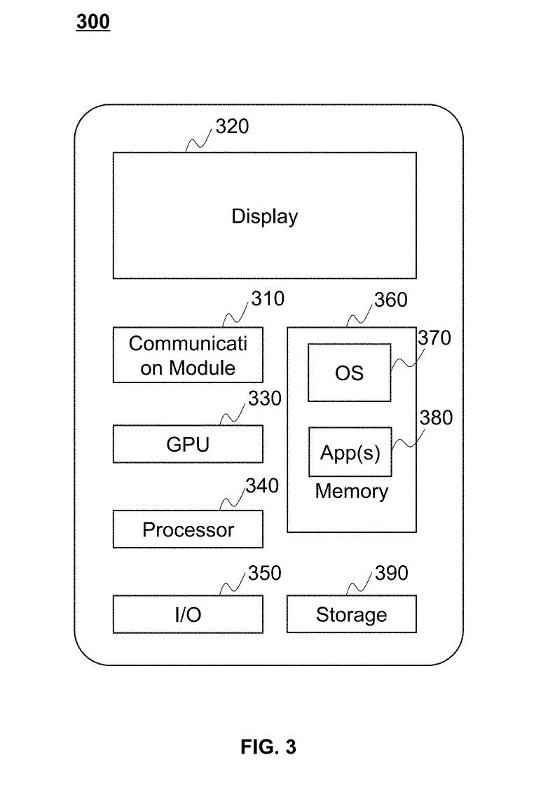

FIG. 3 is a schematic diagram illustrating exemplary hardware and/or software components of a mobile device 300 according to some embodiments of the present disclosure. As illustrated in FIG. 3, the mobile device 300 may include a communication module 310, a display 320, a graphics processing unit (GPU) 330, a processor 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the processor 340. The applications 380 may include a browser or any other suitable apps for transmitting, receiving and presenting information relating to the status of the vehicle 140 (e.g., the location of the vehicle 140) from the server 110. User interactions with the information stream may be achieved via the I/O 350 and provided to the server 110 and/or other components of the vehicle sharing system 100 via the network 120. In some embodiments, a user may borrow (or rent) a vehicle via the mobile device 300. The user may also control the lock of the vehicle via the mobile device 300. For example, the user may input an instruction to close the lock via the mobile device 300.

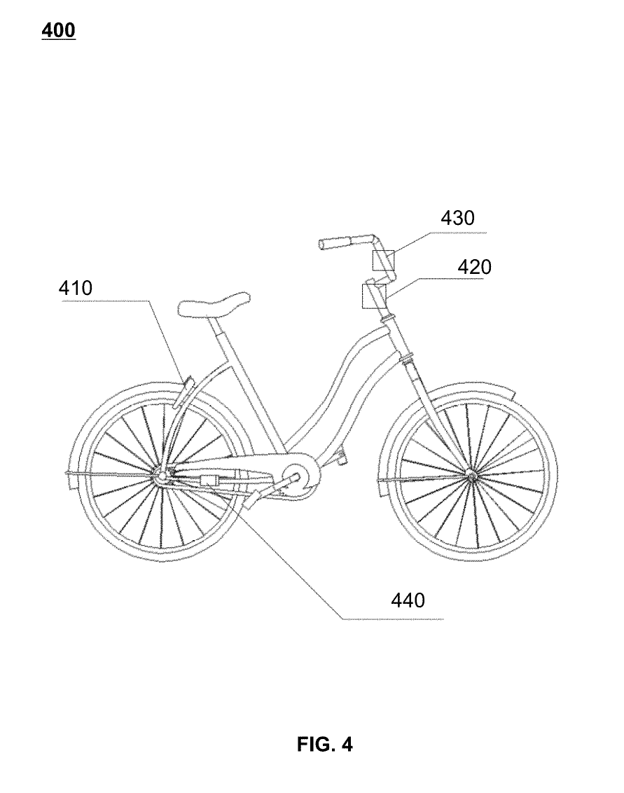

FIG. 4 is a schematic diagram illustrating an exemplary vehicle according to some embodiments of the present disclosure. The vehicle 400 may be an embodiment of the vehicle 140 as described elsewhere in this disclosure (e.g., FIG. 1 and the relevant descriptions thereof). The vehicle 400 may include any combination of mechanisms to implement the functions thereof described in this disclosure. In the present application, the vehicle 140 (and the vehicle 400) may be described in the form of bicycle as examples for illustration purposes, but it should not be interpreted to limit the vehicle 140 to the form of bicycle only. The vehicle 140 (and the vehicle 400) can be any type of vehicle including, for example, a unicycle, a bicycle, a tricycle, a tandem, a motor vehicle, an electric vehicle, a moped, etc.

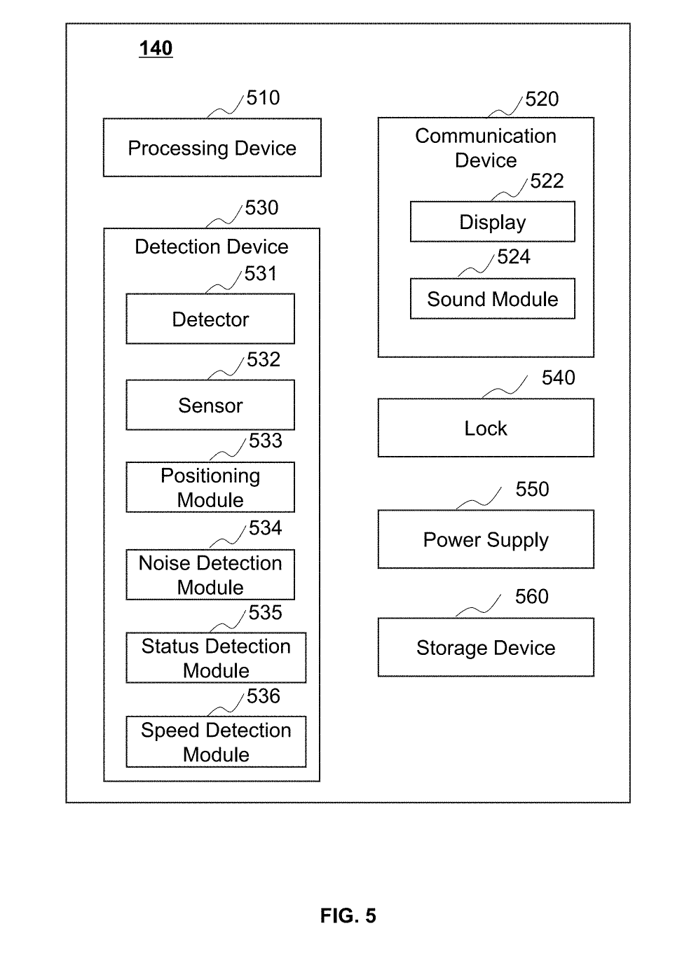

The vehicle 400 may include a lock 410, a processing device 420, a communication device 430, and a detection device 440. In some embodiments, the vehicle 140 may further include a power supply, a storage device, a timing device, and a warning device (not shown in FIG. 4). In some embodiments, one or more components described above may be integrated into the lock 410. Detailed descriptions of the vehicle 140 can be found elsewhere in the present disclosure (e.g., FIG. 5 and the descriptions thereof)

It should be noted that the vehicle 400 illustrated in FIG. 4 is merely provided for illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 5 is a block diagram illustrating hardware and/or software components of an exemplary processing device of a vehicle according to some embodiments of the present disclosure. The vehicle 140 may include a processing device 510, a communication device 520, a detection device 530, a lock 540, a power supply 550, and a storage device 560.

The processing device 510 may be configured to process information captured by the detection device 530. The processing device 510 may transmit the processed information to the communication device 520. In some embodiments, the processing device 510 may obtain multimedia information multimedia information associated with a user. The multimedia information being detected by at least one detector (e.g., the detection device 530) installed on the vehicle 140. The processing device 510 may determine at least one behavior of the user based on the multimedia information. The processing device 510 may generate at least one message in response to the behavior of the user. The processing device 510 may transmit the message to the vehicle 140 or a terminal device of the user.

In some embodiments, the processing device 510 may be further configured to obtain information associated with the vehicle 140. The processing device 510 may determine broadcast data based on the information associated with the vehicle 140. The processing device 510 may transmit the broadcast data to the vehicle 140 or a terminal device of a user that uses the vehicle 140.

The communication device 520 may be configured to communicate with and/or transmit information to the user of the vehicle 140. The communication device 520 may include a display 522 and a sound module 524. The display 522 may be configured to display information relating to the vehicle 140 and/or the user of the vehicle 140 in the form of video, written language, picture, or the like. The sound module 524 may be configured to broadcast information relating to the vehicle 140 and/or the user of the vehicle 140 in the form of audio. The information relating to the vehicle and/or the user of the vehicle may be captured by the detection device 530.

The detection device 530 may be configured to capture information relating to the vehicle 140 and/or the user of the vehicle. The information captured by the detection device 530 may be transmitted the processing device 510 for processing or the storage device 560 for storage. The detection device 530 may include a detector 531, a sensor 532, a positioning module 533, a noise detection module 534, a status detection module 535, and a speed detection module 536.

The detector 531 may be configured to collect the multimedia information by scanning an area associated with the user of the vehicle 140, an area associated with the environment of the vehicle 140, or the like, or any combination thereof.

The sensor 532 may be configured to collect environment information. The sensor 532 may include a temperature sensor, a humidity sensor, a wind sensor, a dust sensor, or the like, or any combination thereof.

The positioning module 533 may be configured to collect a position information of the vehicle 140. The positioning module 533 may collect the location information based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof.

The noise detection module 534 may be configured to collect noise information relating to the vehicle 140. The noise detection module 534 may include a microphone. The microphone may transmit a vibration of the sound to a diaphragm of the microphone. The vibration of the sound may cause a built-in magnet to form a changeable electricity current. The microphone may transmit the changeable electricity current to a sound processing circuit for amplification.

The status detection module 535 may be configured to detect lock information relating to the lock 540. The lock information may refer to a status and/or a status change of the lock 540 of the vehicle 140.

The speed detection module 536 may be configured to collect speed information. The speed information may include an acceleration of the moving direction of the vehicle 140, and an acceleration of the direction perpendicular to the ground in real time.

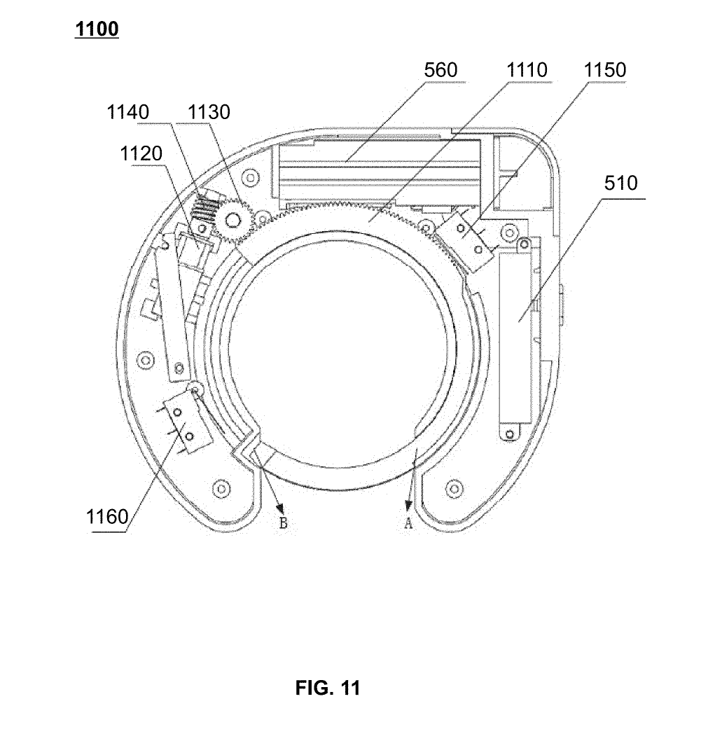

The lock 540 may be configured to secure a vehicle (e.g., a bicycle) to a fixed object such as a lock pillar or a rack. The processing device 510, the communication device 520, the detection device 530, the power supply 550 and the storage device 560 may be integrated into the lock 540. Detailed descriptions of the lock 540 can be found elsewhere in the present disclosure (e.g., FIG. 11 and the descriptions thereof).

The power supply 550 may be configured to provide the power for operations of components of the lock 540. In some embodiments, the power supply 550 may be a battery.

The storage device 560 may be configured to store information captured by the detection device 530 and information processed by the processing device 510.

In some embodiments, the vehicle 140 may include one or more other modules. For example, the vehicle 510 may include a timing device to determine a time that a user drives or rides the vehicle. As another example, the vehicle 510 may include a warning device to warn the user if the user damages the vehicle 140. In some embodiments, one or more modules described may be integrated into the lock 540. Additionally or alternatively, the processing engine 112 may include one or more similar modules to those of processing device 510 configured to perform at least part of the functions of the processing device 510 disclosed in this application.

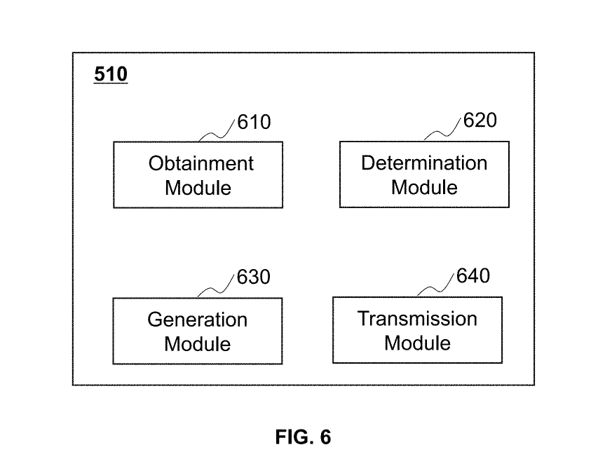

FIG. 6 is a block diagram illustrating an exemplary processing device according to some embodiments of the present disclosure. The processing device 510 may include an obtainment module 610, a determination module 620, a generation module 630, and a transmission module 640. Each module may be a hardware circuit that is designed to perform the following actions, a set of instructions stored in one or more storage media, and/or a combination of the hardware circuit and the one or more storage media.

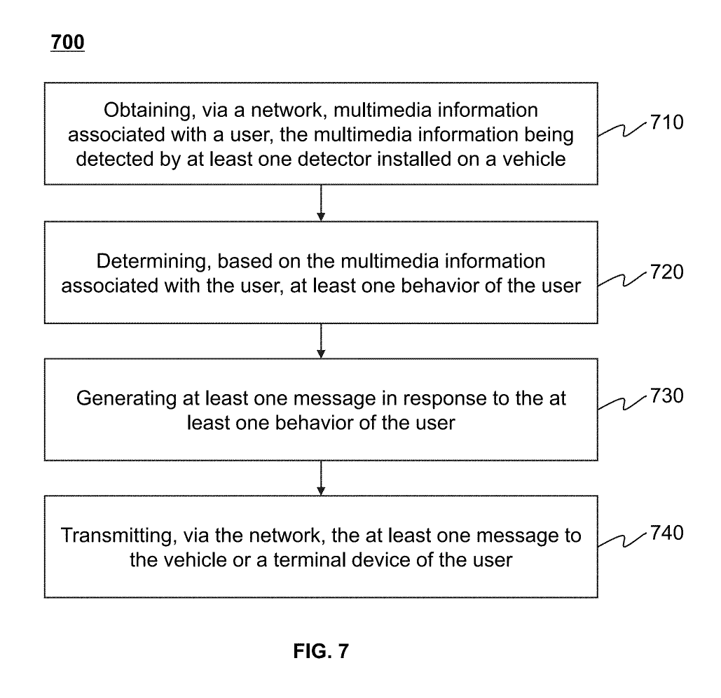

The obtainment module 610 may be configured to obtain information associated with a vehicle 140. The information associated with the vehicle 140 may include multimedia information, speed information, environment information, location information, lock information, noise information, advertisement information, or battery information, or the like, or any combination thereof. Detailed descriptions of the information associated with the vehicle 140 can be found elsewhere in the present disclosure (e.g., FIGS. 7, 8 and 10 and the descriptions thereof).

The determination module 620 may be configured to determine at least one behavior of the user based on the information associated with the vehicle 140. The behavior may include wearing earphones while driving or riding the vehicle 140, making a phone call while driving or riding the vehicle 140, running a red light, damaging the vehicle 140, tampering with the lock 540 of the vehicle 140, using a manual communication, parking the vehicle 140 in a non-public area within a relatively long period, or the like, or any combination thereof. Detailed descriptions of the behavior can be found elsewhere in the present disclosure (e.g., FIG. 7 and the descriptions thereof).

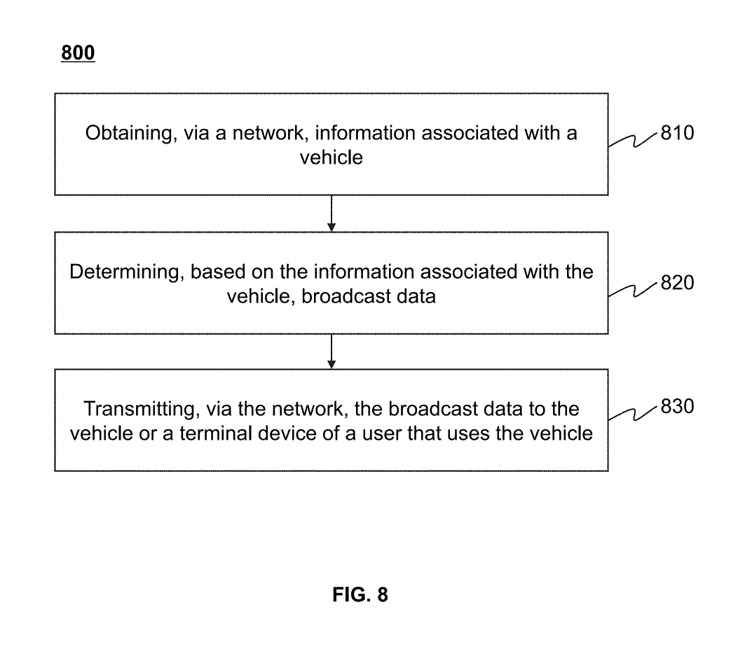

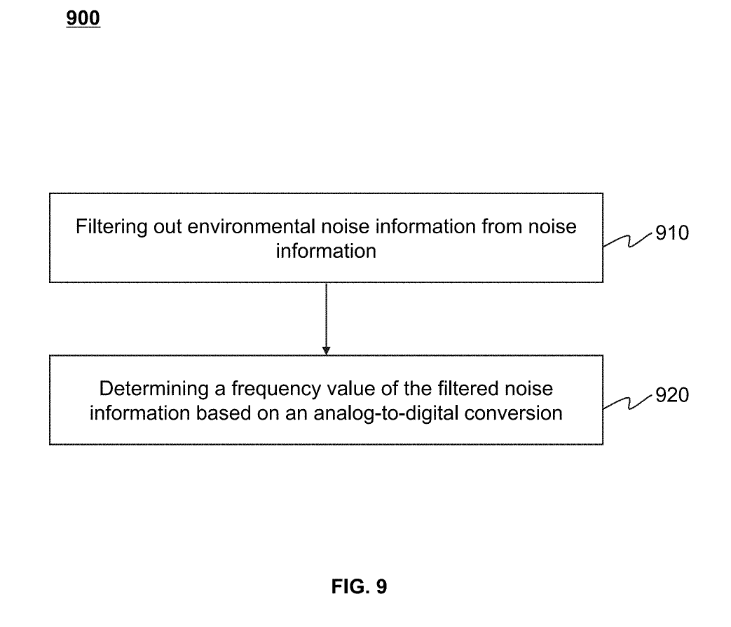

The determination module 620 may be configured to determine broadcast data based on the information associated with the vehicle 140. In some embodiments, the broadcast data may include a location of the vehicle 140, a request for calling for help, a request for tracking the vehicle 140, information relating to the status change of the lock 540 of the vehicle 140, information relating to the at least one environmental parameter, information for reminding the user to drive carefully, a request for repairing at least one part of vehicle 140, information of the advertisement information, information of the remaining capacity of the battery, or the like, or any combination thereof. Detailed descriptions of the broadcast data can be found elsewhere in the present disclosure (e.g., FIGS. 8 and 9 and the descriptions thereof).

The generation module 630 may be configured to generate at least one message in response to the at least one behavior. The message may include a message of reminding the user to travel safely, a warning, a message through sign languages, or the like, or any combination thereof. Detailed descriptions of the message can be found elsewhere in the present disclosure (e.g., FIG. 7 and the descriptions thereof).

The transmission module 640 may be configured to transmit the at least one message to the vehicle 140 or the terminal device 130 of the user via the network 120. In some embodiments, the transmission module 640 may transmit the message in the form of text, sound, or sign languages, or the like, or a combination thereof. For example, the transmission module 640 may transmit the message based on a language that the user speaks. The transmission module 640 may be further configured to transmit the broadcast data to the vehicle 140 or the terminal device 130 of a user that uses the vehicle 140.

In some embodiments, the processing device 510 may include one or more other modules, for example, the processing device 510 may include a storage module to store data generated by the above-mentioned modules. In some embodiments, one or more modules described may be integrated into the processing engine 112. Additionally or alternatively, the processing engine 112 may include one or more similar modules to those of processing device 510 configured to perform at least part of the functions of the processing device 510 disclosed in this application.

It should be noted that the above descriptions of the processing device 510 is provided for the purposes of illustration, and not intended to limit the scope of the present disclosure. For persons having ordinary skills in the art, various modifications and changes in the forms and details of the application of the above method and system may occur without departing from the principles of the present disclosure. However, those variations and modifications also fall within the scope of the present disclosure.

FIG. 7 is a flowchart illustrating an exemplary process 700 for transmitting a message to a vehicle or a terminal device of a user according to some embodiments of the present disclosure. Process 700 may be executed by the vehicle sharing system 100. For example, the process 700 may be implemented as a set of instructions (e.g., an application) stored in a storage device (e.g., the storage 150 and/or a storage device 560 of the vehicle 140). In some embodiments, at least part of the process 700 may be performed by the processing engine 112 (implemented in, for example, the computing device 200 shown in FIG. 2) or the processing device 510 of the vehicle 140. For illustration purposes, the implementation of the process 700 on the processing device 510 is described as an example.

In 710, the processing device 510 (e.g., the obtainment module 610) may obtain multimedia information associated with a user of the vehicle 140 via the network 120. In some embodiments, the multimedia information associated with the user may include image information, sound information, video information, or the like, or any combination thereof.

In some embodiments, the image information may include one or more images of the user while using the vehicle 140. The image information may also include one or more images associated with the environment relating to the vehicle 140. The images associated with the environment may include one or more images of nearby shops relating to the vehicle 140 and/or one or more images of nearby roads (e.g., traffic lights, road reconstruction, traffic flows) relating to the vehicle 140, or the like, or any combination thereof.

In some embodiments, the sound information may include one or more sounds of the user while using the vehicle 140, e.g., making a phone call, interacting with the vehicle 140, etc. The video information may include one or more videos of the user while using the vehicle 140 and/or one or more videos associated with the environment of the user while using the vehicle 140. The videos associated with the environment of the user may include one or more videos of nearby shops of the vehicle 140 and/or one or more images of nearby roads (e.g., traffic lights, road reconstruction, traffic flows) of the vehicle 140, or the like, or any combination thereof.

In some embodiments, the processing device 510 may obtain the multimedia information captured by a detection device 530 of the vehicle 140. The detection device 530 may include a detector 531. The detector 531 may include a camera, a video camera, etc. In some embodiments, the detector 531 may collect the multimedia information by scanning an area associated with the user of the vehicle 140, an area associated with the environment of the vehicle 140, or the like, or any combination thereof. After collecting the multimedia information, the detector 531 may transmit the multimedia information to the processing device 510.

The vehicle sharing system 100 may control a status of the detector 531 (e.g., an operating status, a non-operating status). In some embodiments, the processing device 510 may automatically obtain the multimedia information at regular intervals and/or at irregular intervals. A time interval relating to the regular intervals and/or the irregular intervals may be a predetermined value configured in the vehicle sharing system 100. Alternatively or additionally, the user of the vehicle 140 may dynamically set the time interval by controlling the status of the detector 531 via the terminal device 130 of the user.

Alternatively or additionally, the user of the vehicle 140 may control the status of the detector 531. In some embodiments, the detector 531 may collect the multimedia information if the user enters certain input via, for example, the user interface of the terminal device 130. For example, if the user of the vehicle 140 puts the detector 531 into the operating status by pressing a button, the processing device 510 may obtain the multimedia information from the detector 531. As another example, if the user of the vehicle 140 puts the detector 531 into the non-operating status, the processing device 510 may not obtain the multimedia information. In some embodiments, the user of the vehicle 140 may be prevented from controlling the status of the detector 531. For example, the detector 531 may detect whether the user disassembles the seat, whether a tire of the vehicle 140 needs to inflate, etc.

In 720, the processing device 510 (e.g., the determination module 620) may determine at least one behavior of the user based on the multimedia information associated with the user. The behavior may include wearing earphones while driving or riding the vehicle 140, making a phone call while driving or riding the vehicle 140, running a red light, damaging the vehicle 140, tampering with the lock 540 of the vehicle 140, using a manual communication, parking the vehicle 140 in a non-public area within a relatively long period, or the like, or any combination thereof.

In some embodiments, the processing device 510 may determine the behavior of the user based on a recognition technique. The recognition technique may include an image recognition technique and/or a sound recognition technique. The image recognition may include text recognition, digital image processing, and recognition, object recognition, etc. The sound recognition may include isolated word recognition, keyword recognition, continuous sound recognition, etc.

In some embodiments, the processing device 510 may extract feature information from the multimedia information based on the recognition technique. The feature information may include features that can represent the characteristics of the multimedia information. For example, if an image or a video shows an act by the user of wearing earphones while driving or riding the vehicle 140, the feature information of the image or the video may include a face of the user of the vehicle 140, objects of the earphones covering ears or nears to the ears. As another example, if an image or a video shows an act by the user of running a red light, the feature information of the image(s) or the video(s) may include a face of the user of the vehicle 140, the red light, and the scene that the user and the vehicle 140 are in the middle of a road associated with the red light.

The processing device 510 may then determine the behavior of the user based on the feature information and a corresponding relationship (e.g., a mapping relationship, a pre-trained model) between feature information and behaviors. The processing device 510 may pre-store the corresponding relationship between the feature information and the behaviors. For example, if the feature information includes a face of the user of the vehicle 140 or objects of the earphones covering ears or nears to the ears, the processing device 510 may determine a corresponding behavior that the user wears the earphones while driving or riding the vehicle 140 based on the corresponding relationship. As another example, if the feature information includes a face of the user of the vehicle 140, the red light, and/or the scene that the user and the vehicle 140 are in the middle of a road associated with the red light, the processing device 510 may determine a corresponding behavior that the user runs the red light based on the corresponding relationship.

In some embodiments, the processing device 510 may determine, based on the feature information and the corresponding relationship, a behavior of the user. The behavior may include but not limited to kicking the vehicle 140, disassembling a portion of the vehicle 140 (e.g., a tire, a seat) from the vehicle 140, parking the vehicle 140 randomly, or the like, or any combination thereof. The processing device 510 may further determine a behavior of the user that the user damages the vehicle 140.

In some embodiments, the processing device 510 may determine, based on the feature information and the relationship, a behavior of the user of parking the vehicle in a non-public area (e.g., home, office) within a relatively long time, or tampering with the lock 540 of the vehicle 140. The processing device 510 may further determine a behavior of the user that the user improperly takes possession of the vehicle 140.

In some embodiments, the processing device 510 may determine, based on the feature information and the corresponding relationship, a behavior of the user of using sign languages. The processing device 510 may determine a behavior of the user that the user uses the manual communication.

In some embodiments, the processing device 510 may determine other behaviors of the user based on the multimedia information. For example, other behaviors of the user may include using a same vehicle for more than one time, driving or riding the vehicle 140 beyond a preset range, parking the vehicle 140 in an area where the parking of the vehicle 140 is allowed, interacting with the vehicle 140 (asking what the temperature is at the moment), or the like, or any combination thereof.

In 730, the processing device 510 (e.g., the generation module 630) may generate at least one message in response to the at least one behavior. For example, if the behavior determined in 720 includes wearing earphones while driving or riding the vehicle 140, making a phone call while driving or riding the vehicle 140, or running a red light, the processing device 510 may generate a message of reminding the user to travel safely, or the like.

As another example, if the behavior determined in 720 includes damaging the vehicle 140, the processing device 510 may generate a warning to the user.

As still another example, if the behavior determined in 720 includes tampering with the lock 540 of the vehicle 140 and/or parking the vehicle 140 in a non-public area within a relatively long period, the processing device 510 may generate a warning to the user.

As still another example, if the behavior determined in 720 includes using a manual communication, the processing device 510 may communicate with the user through the sign languages by displaying gestures to the user. Alternatively or additionally, the processing device 510 may also communicate with the user through the sign languages when the user uses the sign languages via the terminal device 130 of the user.

As still another example, if the behavior determined in 720 includes using the same vehicle for more than one time, the processing device 510 may generate a message of welcoming the use of the vehicle 140 again.

In some embodiments, the processing device 510 may pre-store a corresponding relationship (e.g., a mapping relationship, a model pre-trained by behaviors and messages) between the messages and the behaviors. The processing device 510 may generate the message in response to the behavior based on the corresponding relationship between the messages and the behaviors. For example, the processing device 510 may generate, based on the corresponding relationship, a message of reminding the user of the vehicle 140 to travel safely if it is determined that the user engages an unsafe activity (e.g., the user runs a red light, wears earphones while driving or riding the vehicle 140, makes a phone call while driving or riding the vehicle 140, or the like, or any combination thereof). As another example, the processing device 510 may generate, based on the corresponding relationship, a message of a warning to the vehicle 140 or the terminal device 130 of the user if it is determined that the user is damaging the vehicle 140.

In some embodiments, the processing device 510 may generate a credit evaluation for the user in response to the behavior. If a user has a behavior that may cause damage to the vehicle 140 (e.g., damaging the vehicle 140, tampering with the lock 540 of the vehicle 140), or drives or rides the vehicle 140 unsafely (e.g., wearing earphones while driving or riding the vehicle 140, making a phone call while driving or riding the vehicle 140, running a red light), the processing device 510 may generate a relatively low credit evaluation for the user in such instance. For example, a user with a behavior of damaging the vehicle 140 may be given a relatively low credit evaluation than a user without any such behavior that may cause damage to the vehicle 140 or driving or riding the vehicle 140 unsafely. When a user has a behavior of safeguarding the vehicle 140, the processing device 510 may generate a relatively high credit evaluation. For example, when a user always parks the vehicle 140 in an area where the parking of the vehicle 140 is allowed or recommended, the processing device 510 may generate a relatively high credit evaluation for the user.

In some embodiments, when the credit evaluation is higher than a preset threshold, the vehicle sharing system 100 may give some prize to the user, for example, a free drive or ride, a discount, a coupon, etc.

In 740, the processing device 510 (e.g., the transmission module 640) may transmit the message to the vehicle 140 or the terminal device 130 of the user via the network 120. In some embodiments, the message may be displayed on the display 522 of the vehicle 140 or broadcasted by, for example, a sound displayer of the vehicle 140. In some embodiments, the message may include a message of reminding the user to travel safely, a warning, a message through sign languages, a message of welcoming the use of the vehicle 140 again or the like, or any combination thereof.

In some embodiments, the processing device 510 may transmit the message to the user. The message may be in the form of text, sound, or sign languages, or the like, or a combination thereof. The processing device 510 may transmit the message based on a language that the user speaks. The processing device 510 may determine the language that the user speaks based on the sound recognition and/or the image recognition. For example, if the processing device 510 determines that the user speaks Chinese based on the sound information or the video information, the processing device 510 may transmit the message in Chinese. As another example, if the processing device 510 determines that the user speaks English based on the appearance and/or voice of the user based on the image information or the video information, the processing device 510 may transmit the message in English. As still another example, if the processing device 510 determines that the user speaks English based on appearances and/or voice of the user, the processing device 510 may generate the message in English.

FIG. 8 is a flowchart illustrating an exemplary process for transmitting broadcast data according to some embodiments of the present disclosure. Process 800 may be executed by the vehicle sharing system 100. For example, the process 800 may be implemented as a set of instructions (e.g., an application) stored in a storage device (e.g., the storage 150 and/or a storage device 560 of the vehicle 140). In some embodiments, at least part of the process 800 may be performed by the processing engine 112 (implemented in, for example, the computing device 200 shown in FIG. 2) or the processing device 510 of the vehicle 140. For illustration purposes, the implement of the process 800 on the processing device 510 is described as an example.

In 810, the processing device 510 (e.g., the obtainment module 610) may obtain information associated with a vehicle 140. The information associated with the vehicle 140 may include multimedia information, speed information, environment information, location information, lock information, noise information, advertisement information, or battery information, or the like, or any combination thereof.

In some embodiments, the multimedia information may include image information, sound information, video information, etc. The processing device 510 may obtain the multimedia information through the detection device 530 (e.g., the detector 531). Detailed descriptions of the multimedia information can be found elsewhere in the present disclosure (e.g., FIG. 7 and the descriptions thereof).

In some embodiments, the speed information may include an acceleration of the X-axis, an acceleration of the Y-axis, and an acceleration of the Z-axis in real time. As used herein, either of the X-axis or Y-axis may refer to the moving direction of the vehicle. The Z-axis may refer to a direction perpendicular to the ground. It should be noted that the description of the X-axis, Y-axis, and Z-axis is merely provided for illustration, and not intended to limit the scope of the present disclosure.

The processing device 510 may obtain a first threshold acceleration (i.e., the rate of change of speed of an object with respect to time) in each axis. The first threshold acceleration may be an acceleration in each axis when a user may drive or ride the vehicle 140 under a normal condition. The normal condition may include driving or riding at a safe speed in the moving direction, speeding up at the beginning along the moving direction, speeding up during driving or riding in the moving direction, braking along the moving direction in an emergency, etc.

In some embodiments, the processing device 510 may analyze historical acceleration in the each axis under the normal condition. The processing device 510 may then determine the maximum value of the historical acceleration of the each axis as the first threshold acceleration in the each axis. For example, the maximum value of the historical accelerations in the moving direction (e.g., the X-axis or Y-axis) is 3 m/s² under the normal condition, the first threshold acceleration in the moving direction may be 3 m/s². As another example, the first threshold acceleration in the direction perpendicular to the ground (e.g., Z-axis) may be 10 m/s².

In some embodiments, the first threshold acceleration may be used to determine whether the vehicle 140 collides with other objects (e.g., a vehicle, a tree). For example, if accelerations along the moving direction (X-axis, Y-axis) exceed the first threshold acceleration along the moving direction for a plurality of times within a preset time range and a lock 540 of the vehicle 140 is unlocked, the processing device 510 may determine that the vehicle 140 collides with other objects.

The processing device 510 may also obtain a second threshold acceleration in each axis. The second threshold acceleration may be the maximum acceleration in each axis when a user may drive or ride the vehicle 140 under both the normal condition and an abnormal condition in a historical period. For example, the abnormal condition may include collision of the vehicle 140, transportation of the vehicle 140 without an instruction, etc. The instruction may refer to an instruction for transporting the vehicle 140 by the server 110. The server 110 may transmit the instruction to a working staff. The transportation of the vehicle 140 without instruction may include transporting the vehicle 140 by a truck, a car, etc., without the instruction for transporting the vehicle 140 by the server 110 or the working staff.

In some embodiments, the processing device 510 may analyze historical accelerations of the each axis under both the normal condition and the abnormal condition. The processing device 510 may then determine the maximum value of the historical acceleration in each axis as the second threshold acceleration in each axis. For example, a maximum value of the historical accelerations in the moving direction (e.g., X-axis, or Y-axis) is 5 m/s² under the normal condition and the abnormal condition, a second threshold acceleration of the acceleration in the moving direction may be 5 m/s².

After predetermining the first threshold acceleration and the second threshold acceleration, the processing device 510 may transmit them to the storage device 560 for storage. In some embodiments, the first threshold acceleration and the second threshold acceleration may be preset values configured in the vehicle sharing system 100 (e.g., the storage device 560).

In some embodiments, the processing device 510 may obtain the acceleration of X-axis, the acceleration of Y-axis, and the acceleration of Z-axis via the speed detection module 536. The speed detection module 536 may be connected to the processing device 510. The speed detection module 536 may include at least one sensor for detecting the acceleration (e.g., a triaxial accelerometer). After detecting the speed information of the vehicle 140, the speed detection module 536 may transmit the speed information to the processing device 510.

In some embodiments, the environment information may include at least one environment parameter. The at least one environment parameter may include temperature, humidity, wind, or dust (e.g., PM 2.5), or the like, or any combination thereof. The processing device 510 may obtain the environment information based on the detection device 530 (e.g., the sensor 532). The sensor 532 may include a temperature sensor, a humidity sensor, a wind sensor, a dust sensor, or the like, or any combination thereof. The processing device 510 may obtain the environment information from the detection device 530 (e.g., the sensor 532).

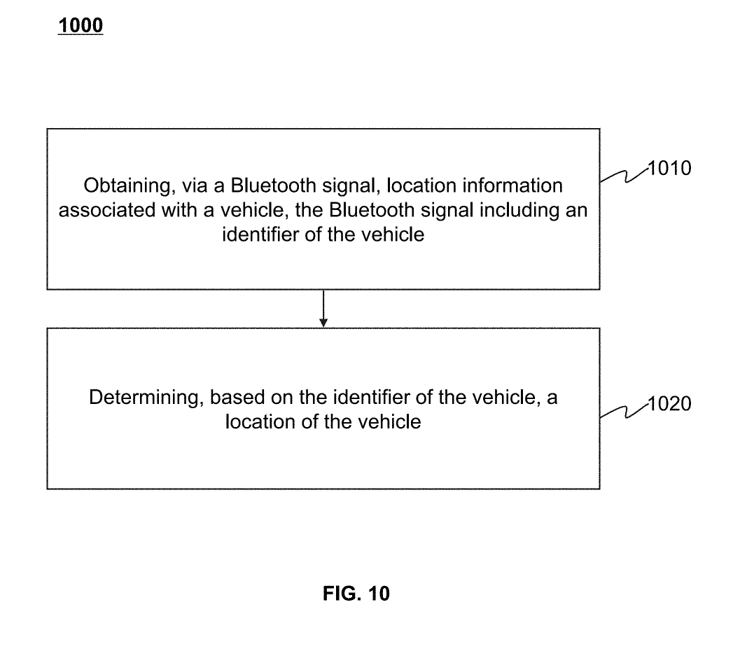

In some embodiments, the location information may include a geographical location including a longitude and a latitude of the vehicle 140. The processing device 510 may obtain the location information through the positioning module 533 or via a Bluetooth signal. The positioning module 533 may collect the location information based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. The positioning module 533 may be connected to the processing device 510 and transmit the location information to the processing device 510. Detailed descriptions of obtaining the location information via the Bluetooth signal can be found elsewhere in the present disclosure (e.g., FIG. 10 and the descriptions thereof).

The lock information may refer to a status and/or a status change of the lock 540 of the vehicle 140. The status may include a locked status, an unlocked status, or the like. The status change may include a status change from a locked status to an unlocked status, a status change from an unlocked status to a locked status. For example, the lock 540 may be locked or unlocked after receiving a request to close or open the lock 540. As another example, the lock 540 may be locked or unlocked in response to the user's input by, for example, pressing a button, pressing a digit button (e.g., button one), inputting a password, scanning a barcode, etc. The processing device 510 may obtain the lock information based on the detection device 530 (e.g., the status detection module 535) and/or the lock 540.

In some embodiments, the user may unlock the lock 540 by inputting a password (e.g., 5549). The user may enter the password by entering a combination of a plurality of digits. The lock information may further include information relating to the buttons that are pressed.

In some embodiments, the noise information may include a noise of a malfunctional chain, a noise of a malfunctional wheel, a noise of a malfunctional tyre, a noise of malfunctional crankset, a noise of a malfunctional pedal, a noise of a malfunctional rear crankset, or the like, or any combination thereof. The processing device 510 may obtain the noise information based on the noise detection module 534. The noise detection module 534 may be connected to the processing device 510. The noise detection module 534 may include a microphone. The microphone may transmit a vibration of the sound to a diaphragm of the microphone. The vibration of the sound may cause a built-in magnet to form a changeable electricity current. The microphone may transmit the changeable electricity current to a sound processing circuit for amplification. After detecting the noise information, the noise detection module 534 may transmit the noise information to the processing device 510.

In some embodiments, after detecting the noise information, the noise detection module 534 may transmit the noise information to a band-pass filter. The band-pass filter may be connected to the noise detection module 534 and the processing device 510. The band-pass filter may be configured to filter out environmental noise information from the noise information and transmit the filtered noise information to the processing device 510. Detailed descriptions of filtering out the environmental information can be found elsewhere in the present disclosure (e.g., FIG. 9 and the descriptions thereof).

In some embodiments, the advertisement information may include an identity of a nearby shop, listing information of a new product of the nearby shop, coupon information of the nearby shop, discount information of the nearby shop, an advertisement type that the user is interested in, or the like, or any combination thereof. If the distance between the location of the nearby shop and the location of the vehicle 140 is less than a distance threshold, the processing device 510 may obtain the advertisement information.

In some embodiments, the processing device 510 may determine the advertisement type in which the user may be interested based on a query by the user. The advertisement type may include a type of advertisements for restaurants, a type of advertisements for supermarkets, a type of advertisements for drinks, a type of advertisements for clothes, or the like, or any combination thereof. For example, if the user searches for a restaurant, the processing device 510 may determine that the user is interested in the type of advertisements for food.

The processing device 510 may obtain the advertisement information via a Bluetooth signal. The Bluetooth signal may be generated by a beacon station. The beacon station may be configured inside the lock 540 of the vehicle 140. The Bluetooth signal may include an identifier of the vehicle 140 (e.g., the beacon station). The identifier of the vehicle 140 (e.g., the beacon station) may also be associated with at least one nearby shop.

In some embodiments, the battery information may include the remaining capacity of a battery of the vehicle 140. In some embodiments, the battery may be a battery charged by solar energy, kinetic energy (e.g., during a ride of the vehicle 140, the battery may be charged), wind energy, mechanical energy, etc. The battery detection device described in FIG. 5 may determine the remaining capacity of the battery and transmit the remaining capacity of the battery to the processing device 510.

In 820, the processing device 510 (e.g., the determination module 620) may determine broadcast data based on the information associated with the vehicle 140. In some embodiments, the broadcast data may include a location of the vehicle 140, a request for calling for help, a request for tracking the vehicle 140, information relating to the status change of the lock 540 of the vehicle 140, information relating to the at least one environmental parameter, information for reminding the user to drive carefully, a request for repairing at least one part of vehicle 140, information of the advertisement information, information of the remaining capacity of the battery, or the like, or any combination thereof.

In some embodiments, if the processing device 510 determines that the vehicle 140 collides with an object based on the speed information and the lock information, the processing device 510 may further include a request for calling for help and a location of the vehicle 140 in the broadcast data. For example, if the acceleration of X-axis and the acceleration of Z-axis respectively exceed the first threshold acceleration of X-axis (e.g., 3 m/s²) and the first threshold acceleration of Z-axis (e.g., 10 m/s²) for certain times within a preset time range (e.g., 10 seconds), and the lock 540 is unlocked, the processing device 510 may determine that the vehicle 140 collides with an object. As another example, if the accelerations of Y-axis and the accelerations of Z-axis respectively exceed the first threshold acceleration of Y-axis (e.g., 2 m/s²) and the first threshold acceleration of Z-axis (e.g., 10 m/s²) within a preset time range (e.g., 10 seconds) for certain times and the lock 540 is unlocked, the processing device 510 may determine that the vehicle 140 collides with an object. After determining that the vehicle 140 collides with an object, the processing device 510 may include a request for calling for help and the location of the vehicle 140 in the broadcast data.

In some embodiments, if the processing device 510 determines that the vehicle 140 is transported without an instruction based on the speed information and the lock information, the processing device 510 may further include a request for tracking the vehicle 140 in the broadcast data. The instruction may instruct a working staff to track the vehicle 140. The working staff may receive the instruction from the server 110. In an embodiment, if the accelerations of X-axis or the accelerations of Y-axis respectively exceed the second threshold acceleration of X-axis (e.g., 5 m/s²) and the second threshold acceleration of Y-axis (e.g., 5 m/s²), there is no instruction to transport the vehicle 140 and the lock 540 is locked, the processing device 510 may determine that the vehicle 140 is transported without the instruction.

In some embodiments, if the lock information determined in 810 includes a status change of the lock 540 of the vehicle 140 from locked status to unlocked status or from unlocked status to locked status, the processing device 510 may determine that the broadcast data includes information relating to the status change of the lock of the vehicle 140. For example, if the lock 540 of the vehicle 140 is being locked, the broadcast data may include the text or sound indicating the phase “successfully locked.” As another example, if the lock 540 of the vehicle 140 is being unlocked, the broadcast data may include the text or sound indicating the phase “successfully unlocked.” As still another example, if the vehicle sharing system 100 fails to lock the lock 540, the broadcast data may include the text or sound indicating the phrase “fail to lock.” As still another example, if the vehicle sharing system 100 fails to unlock the lock 540, the broadcast data may include the text or sound indicating the phrase “fail to unlock.” As still another example, if a user locks or unlocks the vehicle 140 by inputting a password, the broadcast data may include the text or sound indicating the phase “the password is right,” “the password is wrong,” etc. In some embodiments, if a digit button representing 1 is pressed, the broadcast data may include information relation relating to 1.

In some embodiments, if the value of the at least one environmental parameter determined in 810 exceeds a threshold, the processing device 510 may include information relating to the at least one environmental parameter in the broadcast data. The threshold may be a predetermined value configured in the vehicle sharing system 100. Alternatively or additionally, the user of the vehicle 140 may dynamically set the threshold via the terminal device 130 of the user or the display 522 of the vehicle 140.

In some embodiments, if the processing device 510 determines that at least one part of the vehicle 140 is malfunctional based on the noise information, the processing device 510 may include reminding the user to drive carefully in the broadcast data. The broadcast data may further include a request for repairing the malfunctional part of the vehicle 140. The request may be transmitted to the server 110. The server 110 may then transmit the request to a working staff.

In some embodiments, if a distance between the location of the vehicle 140 and the location of a shop is less than a distance threshold based on the location information, the processing device 510 may include advertisement information of the shop in the broadcast data. The threshold may be a predetermined value configured in the vehicle sharing system 100. Alternatively or additionally, the user of the vehicle 140 may dynamically set the threshold via the terminal device 130 of the user or the display 522 of the vehicle 140.

In some embodiments, if the information associated with the vehicle 140 includes the battery information of remaining capacity of the battery, the processing device 510 may include information relating to the remaining capacity of the battery in the broadcast data.

In 830, the processing device 510 (e.g., the transmission module 640) may transmit the broadcast data to the vehicle 140 or a terminal device 130 of a user that uses the vehicle 140.

In some embodiments, the processing device 510 may transmit the broadcast data in the form of sound via the communication device 520. The communication device 520 may include a display 522 and a sound module 524. Specifically, the processing device 510 may transmit the broadcast data in the form of sound via the sound module 524. The sound module 524 may be connected to the processing device 510. The sound module 524 may include a sound chip and a loudspeaker. The sound chip may be configured to obtain the broadcast data and converse the broadcast data into sound signals. The loudspeaker may broadcast the sound signals. In some embodiments, the loudspeaker may broadcast amplified and filtered sound signals. Specifically, the sound module 524 may further include a signal amplifier, a signal filter. The signal amplifier may be configured to amplify the sound signal. The signal filter may be configured to filter the sound signal.

In some embodiments, the processing device 510 may transmit the broadcast data in the form of text via the communication device 520 (e.g., the display 522).

In some embodiments, the processing device 510 may only transmit the broadcast data and/or the request in response to an instruction of the user. The instruction may be sent in response to the pressing of a button by the user. In some embodiments, the user may control what broadcast data and/or the request that the processing device 510 transmits. For example, if the user wants to obtain the environmental parameters, the processing device 510 may transmit the environmental parameters to the vehicle 140 or the terminal device 130 of the user. The user may control what broadcast data and/or the request the processing device 510 transmits by the terminal device 130 of the user or the vehicle 140 (e.g., the communication device 520).

It should be noted that the above description of the process 800 is merely provided for illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 9 is a flowchart illustrating an exemplary process for determining a frequency value of filtered noise information based on an analog-to-digital converter according to some embodiments of the present disclosure. Process 900 may be executed by the vehicle sharing system 100. For example, the process 900 may be implemented as a set of instructions (e.g., an application) stored in a storage device (e.g., the storage 150, processing device 510, and/or a storage device 560 of the vehicle 140). In some embodiments, at least part of the process 900 may be performed by the processing engine 112 (implemented in, for example, the computing device 200 shown in FIG. 2) or the processing device 510 of the vehicle 140. For illustration purposes, the implement of the process 900 on the processing device 510 is described as an example.

In 910, the processing device 510 (e.g., the determination module 620) may filter out environment noise information from noise information. The noise detection module 534 may collect the noise information. The noise information may pass through a band-pass filter. The band-pass filter may filter out the environmental noise from the noise information for generating filtered noise information.

In 920, the processing device 510 (e.g., the determination module 620) may determine a frequency value of the filtered noise information. The processing device 510 may determine the frequency value of the filtered noise based on a digital signal processing (DSP) technique (e.g., an analog-to-digital converter).

In some embodiments, after obtaining the noise information (or the filtered noise information), the processing device 510 may analyze the noise information based on the DSP technique. Since different malfunctional parts of the vehicle 140 may generate different frequency values of noises, the processing device 510 may determine a malfunctional part of the vehicle 140 based on the analyzing result. In some embodiments, the malfunctional part of the vehicle 140 may include a chain, a wheel, a tyre, a crankset, a pedal, a rear crankset, or the like, or any combination thereof.

In some embodiments, the processing device 510 may further determine the malfunctional part of the vehicle 140 based on a relationship (e.g., a mapping relationship, a pre-trained model) between a frequency value of a noise and a malfunctional part of the vehicle 140. For example, if a frequency value of the noise corresponds to a frequency value range of a malfunctional wheel of the vehicle 140, the processing device 510 may determine that the wheel of the vehicle 140 is malfunctional.

In some embodiments, if there are two or more malfunctional parts of the vehicle 140, the noise information may include two or more noise signals. Each malfunctional part of the vehicle may correspond to a noise signal. Each noise signal may include a frequency value. The band-filter may divide the frequency values of the two or more noise signals. The processing device 510 may then determine a frequency value of each of the two or more noise signals based on the DSP (e.g., an analog-to-digital converter). The processing device 510 may determine the malfunctional part of the vehicle 140 corresponding to the frequency value of each of the two or more noise signals.

It should be noted that the above description of the process 900 is merely provided for illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 10 is a flowchart illustrating an exemplary process for determining a location of a vehicle according to some embodiments of the present disclosure. Process 1000 may be executed by the vehicle sharing system 100. For example, the process 1000 may be implemented as a set of instructions (e.g., an application) stored in a storage device (e.g., the storage 150, processing device 510 and/or a storage device 560 of the vehicle 140). In some embodiments, at least part of the process 1000 may be performed by the processing engine 112 (implemented in, for example, the computing device 200 shown in FIG. 2) or the processing device 510 of the vehicle 140. For illustration purposes, the implement of the process 1000 on the processing device 510 is described as an example.

In 1010, the processing device 510 (e.g., the obtainment module 610) may obtain location information associated with the vehicle 140 via a Bluetooth signal. The lock 540 may include a beacon station. The beacon station may generate the Bluetooth signal. The Bluetooth signal may include an identifier of the vehicle 140 (e.g., the lock 540). For example, the identifier of the vehicle 140 may include a barcode, a quick response (QR) code, a serial number including letters and/or digits, or the like, or any combination thereof.

In 1020, the processing device 510 (or the obtainment module 610) may determine a location of the vehicle 140 based on the identifier of the vehicle 140. The location of the vehicle 140 may include a geographical location with a longitude and a latitude of the vehicle 140. The processing device 510 may determine the location based on the barcode, the quick response (QR) code, the serial number including letters and/or digits, or the like, or any combination thereof.

In some embodiments, the processing device 510 may determine the location of the vehicle 140 via the positioning module 533 of the vehicle 140. The positioning module 533 may determine the location of the vehicle 140 based on a positioning technique. The positioning technique may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof.

It should be noted that the above description of the process 1000 is merely provided for illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 11 is a schematic diagram illustrating an exemplary lock according to some embodiments of the present disclosure. The lock 1100 may be an embodiment of the lock 540 as described elsewhere in this disclosure (e.g., FIGS. 4 and 5, and the descriptions thereof). In some embodiments, the lock 1100 may be configured to secure a vehicle (e.g., a bicycle) to a fixed object such as a lock pillar or a rack. The lock 1100 may include any combination of mechanisms to implement the functions thereof described in this disclosure.

In some embodiments, the lock 1100 may include a processing device 510, a power supply 550, a locking mechanism 1110, a control device, and a status detection device.

The processing device 510 may process information and/or instruction related to performing one or more functions as described elsewhere in this disclosure. See FIGS. 4 to 5 and the descriptions thereof. The processing device 510 may also control the operation of other components of the lock 1100 (e.g., the control device, the status detection device) based on the acquired and/or the processed information and/or instruction. In some embodiments, the processing device 510 may be a circuit board.

The power supply 550 may provide the power for operations of components of the lock 1100 (e.g., the processing device 510, the control device, the status detection device). In some embodiments, the power supply 550 may be a battery.

The locking mechanism 1110 may include a lock tongue, a bolt, a lock cylinder, or the like. The lock mechanism 1110 may be movable along a predetermined pathway. The status of the lock 1100 may be changed with the movement of the locking mechanism 1110. For example, the lock 1100 may have a locked status when an end of the locking mechanism 1110 is in the position B as illustrated in FIG. 11. The lock 1100 may have an open status when the end of the locking mechanism 1110 is the locking mechanism 1110 is not in the position B (e.g., in the position A).

In some embodiments, the first position of the locking mechanism 1110 as described elsewhere in this disclosure may be the position B. The second position the locking mechanism 1110 is as described elsewhere in this disclosure may be any position other than the position B. For example, the second position may be the position A.

The control device may control the movement of the locking mechanism 1110 to control the status of the lock 1100 (i.e., to open or lock the lock 1100). The control device may include a motor 1120, a worm gear 1130, and a worm 1140. The motor 1120 may drive the worm gear 1130 to revolve in a certain direction, which may cause the worm 1140 to revolve. The revolution of the worm 1140 may cause the locking mechanism to move toward a certain position.

For example, the motor 1120 may drive the worm gear 1130 to revolve in a first direction, which may cause the worm 1140 to revolve in the anticlockwise direction in FIG. 11. The revolution of worm 1140 may further cause the locking mechanism 1110 to move toward the position B via the gear engagement. As another example, the motor 1120 may drive the worm gear 1130 to revolve in the opposite direction of the first direction, which may cause the worm 1140 to revolve in the clockwise direction in FIG. 11. The revolution of worm 1140 may further cause the locking mechanism 1110 to move toward the position A. In some embodiments, the motor 1120 may be a direct-current motor.

The status detection device may determine the status of the lock 1100. The status detection device may include a first switch 1150 and a second switch 1160. The first switch 1150 may be configured to detect whether the lock 1100 is in the locked status. When at least part of the locking mechanism 1110 is physically connected to the first switch 1150, the status detection device may determine that the lock 1100 is in the locked status. In some embodiments, the first switch 1150 may include a spring strip, which may have a first contact. When at least part of the locking mechanism 1110 is physically connected to the first contact of the first switch 1150, the status detection device may determine that the lock 1100 may be in the locked status.

The second switch 1160 may be configured to determine whether the lock 1100 is in the open status. When the locking mechanism 1110 is physically connected to the second switch 1160, the status detection device may determine that the lock 1100 is in the open status. In some embodiments, the second switch 1160 may include a spring strip, which may include a second contact. When the locking mechanism 1110 is physically connected to the second contact of the second switch 1160, the status detection device may determine that the lock 1100 is in the open status.

In some embodiments, the lock 1100 may include only one of the first switch 1150 and the second switch 1160. For example, the lock 1100 may only include the first switch 1150. When the locking mechanism 1110 is physically connected to the first switch 1150 (or the first contact of the first switch 1150), the lock 1100 is in the locked status. When the locking mechanism 1110 is not physically connected to the first switch 1150 (or the first contact of the first switch 1150), the status detection device may determine that the lock 1100 is in the open status.

It should be noted that the lock 1100 illustrated in FIG. 11 is merely provided for illustration, and not intended to limit the scope of the present disclosure. For persons having ordinary skills in the art, multiple variations and modifications may be made under the teachings of the present disclosure. However, those variations and modifications do not depart from the scope of the present disclosure.

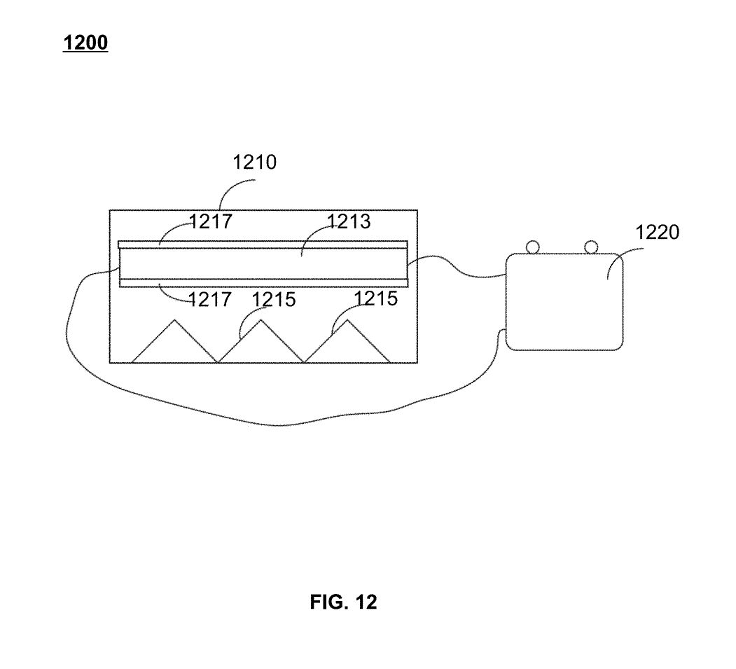

FIG. 12 is a schematic diagram illustrating an exemplary power supply according to some embodiments of the present disclosure. The power supply 1200 may be an embodiment of the power supply 550 as described elsewhere in this disclosure (e.g., FIGS. 4 to 10 and the relevant descriptions thereof). In some embodiments, the power supply 1200 may provide the power for operations of components of the lock 1100 (e.g., the processing device 510, the control device, the status detection device). The power supply 1200 may include any combination of mechanisms to implement the functions thereof described in this disclosure.

The power supply 1200 may include a solar energy module 1210 and a battery 1220. In some embodiments, the solar energy module 1210 may include a double-sided solar panel 1213 and a plurality of reflectos 1215. The plurality of reflectos 1215 may be constructed below the double-sided solar panel 1213. The solar energy module 1210 may be configured to generate electricity. The battery 1220 may be configured to store the electricity generated by the solar energy module 1210 (e.g., the double-sided solar panel 1213).

In some embodiments, an upper side and a lower side of the double-sided solar panel 1213 may be configured with tempered glasses 1217. The plurality of reflectors 1215 may be configured to reflect lights to the double-sided solar panel 1213 through the tempered glass 1217. The double-sided solar panel 1213 may then generate electricity based on the lights. A shape of the reflector 1215 may include a triangle.

In some embodiments, the tempered glass 1217 may be connected to the double-sided solar panel 1213 by an adhesive. For example, the adhesive may include a water-soluble adhesive (e.g., polyvinyl alcohol), a thermoplastic adhesive (e.g., polystyrene, polyurethane), an emulsion adhesive (e.g., polyvinyl acetate resin, acrylic resin), etc.

In some embodiments, the double-sided solar panel 1213 may be connected to the battery 1220. The battery 1220 may be connected to a power detection module (not shown in FIG. 12). The power detection module may be configured to detect remaining capacity of the battery 1220.

It should be noted that the power supply 1200 illustrated in FIG. 12 is merely provided for illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system comprising:
a storage device storing a set of instructions; and
one or more processors in communication with the storage device, wherein when executing the set of instructions, the one or more processors are configured to cause the system to:
obtain, via a network, multimedia information associated with a user, the multimedia information being detected by at least one detector installed on a vehicle;
determine, based on the multimedia information associated with the user, at least one behavior of the user;
generate at least one message in response to the at least one behavior of the user; and
transmit, via the network, the at least one message to the vehicle or a terminal device of the user.

2. The system of claim 1, wherein the multimedia information associated with the user includes at least one of: image information, sound information, or video information.

3. The system of claim 1, wherein the at least one behavior of the user includes at least one of: wearing earphones while driving or riding the vehicle, making a phone call while driving or riding the vehicle, running a red light, damaging the vehicle, tampering with a lock of the vehicle, or using a manual communication.

4. The system of claim 3, wherein the one or more processors are further configured to cause the system to:
determine whether the at least one behavior of the user includes at least one of: wearing earphones while driving or riding the vehicle, making a phone call while driving or riding the vehicle, or running a red light; and
in response to a result of the determination that the at least one behavior of the user includes at least one of: wearing earphones while driving or riding the vehicle, making a phone call while driving or riding the vehicle, or running a red light, transmit, via the network, a message of reminding the user to travel safely to the vehicle or the terminal device.

5. The system of claim 3, wherein the one or more processors are further configured to cause the system to:
determine whether the at least one behavior of the user includes damaging the vehicle; and
in response to a result of the determination that the at least one behavior of the user includes damaging the vehicle, transmit, via the network, a warning to the vehicle or the terminal device.

6. The system of claim 3, wherein the one or more processors are further configured to cause the system to:
determine whether the at least one behavior of the user includes tampering with a lock of the vehicle; and
in response to a result of the determination that the at least one behavior of the user includes tampering with the lock of the vehicle,
transmit, via the network, a warning to the vehicle or the terminal device, and
transmit, via the network, the multimedia information associated with the user and an identifier of the vehicle to a server.

7. The system of claim 3, wherein the one or more processors are further configured to cause the system to:
determine whether the at least one behavior of the user includes using a manual communication; and
in response to a result of the determination that the at least one behavior of the user includes using a manual communication, transmit, via the network, a message through sign languages to the vehicle or the terminal device of the user.

8. A system, comprising:
a storage device storing a set of instructions; and
one or more processors in communication with the storage device, wherein when executing the set of instructions, the one or more processors are configured to cause the system to:
obtain, via a network, information associated with a vehicle;
determine, based on the information associated with the vehicle, broadcast data; and
transmit, via the network, the broadcast data to the vehicle or a terminal device of a user that uses the vehicle.

9. The system of claim 8, wherein the information associated with the vehicle includes at least one of multimedia information, speed information, environment information, location information, lock information, noise information, advertisement information, or battery information.

10. The system of claim 9, wherein:
the lock information includes a status change of a lock of the vehicle from being locked to unlocked or from being unlocked to locked; and
the broadcast data include broadcast data relating to the status change of the lock of the vehicle.

11. The system of claim 9, wherein:
the environment information is associated with an area where the vehicle is located and the environment information includes at least one environmental parameter of the vehicle, the at least one environmental parameter including at least one of temperature, humidity, wind, or dust; and
the one or more processors are configured to cause the system to:
determine whether a value of the at least one environmental parameter exceeds a threshold; and
in response to a result of the determination that the at least one environmental parameter exceeds the threshold, transmit, via the network, broadcast data relating to the at least one environmental parameter to the vehicle or the terminal device of the user.

12. The system of claim 9, wherein:
the speed information includes an acceleration of X-axis, an acceleration of Y-axis, and an acceleration of Z-axis; and
the one or more processors are configured to cause the system to:
determine whether the acceleration of X-axis and the acceleration of Z-axis are abnormal when a lock of the vehicle is unlocked or the acceleration of Y-axis and the acceleration of Z-axis are abnormal when the lock is unlocked; and
in response to a result of the determination that the acceleration of X-axis and the acceleration of Z-axis are abnormal when the lock is unlocked or the acceleration of Y-axis and the acceleration of Z-axis are abnormal when the lock is unlocked, transmit, via the network, a request for calling for help and a location of the vehicle to a server.

13. The system of claim 12, wherein the one or more processors are further configured to cause the system to:
determine whether the acceleration of X-axis or the acceleration of Y-axis is abnormal when the lock is locked; and
in response to a result of the determination that the acceleration of X-axis or the acceleration of Y-axis is abnormal when the lock is locked, transmit, via the network, a request for tracking the vehicle and the location of the vehicle to a server.

14. The system of claim 9, wherein the one or more processors are further configured to cause the system to:
determine, based on the noise information, whether at least one part of the vehicle is malfunctional; and
in response to a result of the determination that the at least one part of the vehicle is malfunctional,
transmit, via the network, broadcast data for reminding the user to drive carefully to the vehicle or the terminal device of the user, and
transmit, via the network, a request for repairing the at least one part of vehicle that is malfunctional to a server.

15. The system of claim 14, wherein the one or more processors are further configured to cause the system to:
filter out environmental noise information from the noise information; and
determine a frequency value of the filtered noise information based on an analog-to-digital converter.

16. The system of claim 9, wherein:
the location information includes the location of the vehicle and the advertisement information includes a location of a shop;
the one or more processors are configured to cause the system to:
determine whether a distance between the location of the vehicle and the location of the shop is less than a distance threshold; and
in response to a result of the determination that the distance between the location of the vehicle and the location of the shop is less than a distance threshold, transmit, via the network, broadcast data of the advertisement information to the vehicle or the terminal device of the user.

17. The system of claim 16, wherein the one or more processors are further configured to cause the system to:
obtain, via a Bluetooth signal, the location information associated with the vehicle, the Bluetooth signal including an identifier of the vehicle; and
determine, based on the identifier of the vehicle, the location of the vehicle.

18. The system of claim 9, wherein:
the battery information includes remaining capacity of a battery of the vehicle; and
the one or more processors are configured to cause the system to:
transmit, via the network, broadcast data of the remaining capacity of the battery to a server.

19-36. (canceled)

37. A vehicle, comprising:
a storage device including a set of instructions; and
a processor in communication with the storage device, wherein when executing the set of instructions, the processor is configured to cause the vehicle to:
obtain multimedia information associated with a user, the multimedia information being detected by at least one detector installed on the vehicle;
transmit, via a network, the multimedia information associated with the user to a server;
obtain, via the network, from the server, at least one message indicating that a behavior of the user determined based on the multimedia information; and
broadcast the at least one message to the user or a server.

38-58. (canceled)

59. The vehicle of claim 37, wherein the multimedia information associated with the user includes at least one of: image information, sound information, or video information.
